(19) United States
(12) Patent Application Publication
(10) Pub. No.: US 2010/0175057 A1
(43) Pub. Date: Jul. 8, 2010

(54) ASSOCIATING ADVERTISEMENTS AND GAME DATA IN A FLASH-BASED GAMING ENVIRONMENT

(76) Inventors: David Simons, Toronto (CA); Kelly Slough, Northampton, MA (US); Steven Woods, Los Altos Hills, CA (US); Chris Micacchi, Toronto (CA)

Correspondence Address: FOLEY & LARDNER LLP, 150 EAST GILMAN STREET, P.O. BOX 1497, MADISON, WI, 53701-1497, US

(21) Appl. No.: 12/471,582

(22) Filed: May 26, 2009

Related U.S. Application Data
(63) Continuation-in-part of application No. 12/349,050, filed on Jan. 6, 2009.

(51) Int. Cl. G06F 9/44

(52) U.S. Cl. 717/168; 717/110

(57) ABSTRACT

A method of associating a service with a computer software product includes loading an executable software file containing software code that upon execution carries out a software program, inputting code into functions of the software file, mapping execution of the functions of the software file, receiving an input identifying a content trigger, identifying a function of the software file associated with the content trigger, and modifying the function associated with the content trigger to cause presentation of service in response to an occurrence of the content trigger. An enhanced software file may be produced that includes the modified function.

### CROSS REFERENCE TO RELATED APPLICATIONS

This application is a continuation in part of U.S. patent application Ser. No. 12/1349,050, filed Jan. 6, 2009, and entitled “ASSOCIATING ADVERTISEMENTS AND GAME DATA IN A FLASH-BASED GAMING ENVIRONMENT.”

### FIELD

The subject of the disclosure relates generally to service insertion within a gaming environment. More specifically, the disclosure relates to associating advertisements and game data in a FLASH-based gaming environment.

### SUMMARY

The Adobe Flash player is a widely available graphical run-time computing environment. It runs on devices ranging from cellular phones to personal computers and is compatible with most operating systems commonly found on such devices. Although originally developed as an environment for producing computer animation sequences and movies, this ubiquitous support has also made it a popular choice as a programming and run-time environment for delivering online video games to consumers.

The executable game format delivered from game developers to game publishers and distributors is Adobe's proprietary Flash SWF (Shockwave Flash) file format. This file consists of binary bytecode instructions and data that is interpreted at runtime by the Flash player application to render the interactive game.

Game publishers and distributors seek to monetize games with a variety of business models including advertising-driven revenue. They may also wish to create a social environment around online Flash games that allows players to compete head to head, compare scores, issue challenges and track their competitor's progress. Flash games as built by the developer and delivered to the publisher do not typically allow a publisher to build advertising into the game or determine the player's current score and progress through a game as it is played.

A representative implementation includes a service insertion toolset and process by which games delivered in the Adobe SWF executable file format can be enhanced, without access to any of the source code files, graphics, fonts or data. While the types of enhancements that can be made with this service insertion toolset are virtually unlimited, the current process applies most directly to enhancements related to adding in-game advertising as well as extracting score and progress information from an actively running game. The types of advertising that can be enabled with this service insertion toolset and process include but are not limited to pre-roll, interstitial and post-roll video ads that occur during natural breaking points in game play, overlay ads that appear during game play without being overly intrusive on the game play experience and product placement advertisements in which branded imagery is added in context to the game play scene. It should be noted that while the present disclosure describes several representative embodiments in terms of using Adobe Flash software, this description should not be interpreted to limit embodiments to use of only the Adobe Flash software product.

In a first representative embodiment, a method of associating a service with a computer software product includes loading an executable software file containing software code that upon execution carries out a software program, receiving an input identifying a content trigger within the software program, identifying a function of the software file associated with the content trigger, and modifying the function of the software file. The function is configured to cause presentation of content in response to an occurrence of the content trigger. The method may further include producing an enhanced software file that includes the modified function.

In a second representative embodiment, a tool for associating a service with a computer software product includes a viewer and a processor. The viewer is configured to present a software program in a user interface and receive user inputs through the user interface. The processor is configured to execute programmed instructions to receive an input through the user interface identifying a content trigger within the software program, identify a function of a software file associated with the content trigger, and modify the function of the software file. The function is configured to cause presentation of content in response to an occurrence of the content trigger. The processor may be further configured to produce an enhanced software file that includes the modified function.

In a third representative embodiment, a computer-readable medium has computer-readable instructions stored thereon that, when executed by a processor, cause a computing device to load an executable software file containing software code that upon execution carries out a software program, receive an input identifying a content trigger within the software program, identify a function of the software file associated with the content trigger, and modify the function of the software file. The function is configured to cause presentation of content in response to an occurrence of the content trigger.

Other principal features and advantages will become apparent to those skilled in the art upon review of the following drawings, the detailed description, and the appended claims.

### BRIEF DESCRIPTION OF THE DRAWINGS

Representative embodiments will hereafter be described with reference to the accompanying drawings.

FIG. 1 is a flow diagram illustrating operations performed by an advertising delivery system in accordance with a representative embodiment.

FIG. 2 is a block diagram illustrating a service insertion tool in accordance with a representative embodiment.

FIG. 3 is a graphical user interface (GUI) for controlling the service insertion tool of FIG. 2 in accordance with a representative embodiment.

FIG. 4 is a GUI for controlling the service insertion tool of FIG. 2 in accordance with a representative embodiment.

FIG. 5 is a GUI for controlling the service insertion tool of FIG. 2 in accordance with a representative embodiment.

FIG. 6 is a GUI for controlling the service insertion tool of FIG. 2 in accordance with a representative embodiment.

FIG. 7 is a general block diagram showing a beaconing service in accordance with a representative embodiment.

### DETAILED DESCRIPTION

The Adobe Flash system includes a visual development environment that saves and works with Flash programs in their “source code” format, which is a proprietary binary-formatted FLA file. When a Flash movie or game is distributed to end users, the Flash development environment “publishes” the service into an executable form. This executable form of Flash service is a proprietary binary-formatted SWF file containing bytecode instructions and data that completely specify the execution of the service. The Flash player is the run-time environment that is responsible for interpreting and executing the bytecode and data in the SWF file.

SWF files contain a series of tags that describe the visual elements and sounds used in the game, along with their movements and transformations. In addition to these tags, the developer of the game can include logic written in the ActionScript scripting language. During the publishing process, this ActionScript logic is transformed from its textual representation to a bytecode representation in the SWF file. While not a completely reversible process, it is possible however to re-interpret this bytecode representation such that the original ActionScript that produced it is approximated sufficiently to allow its modification using a service or advertisement insertion tool.

To demonstrate the operation of a representative embodiment, a set of commercially available online SWF game files from well known game development studios were used. These SWF game files were obtained either directly from the game development studio itself or from a publisher of the game. In all cases, the games were the standard issue as would be given to any and all publishers of the game.

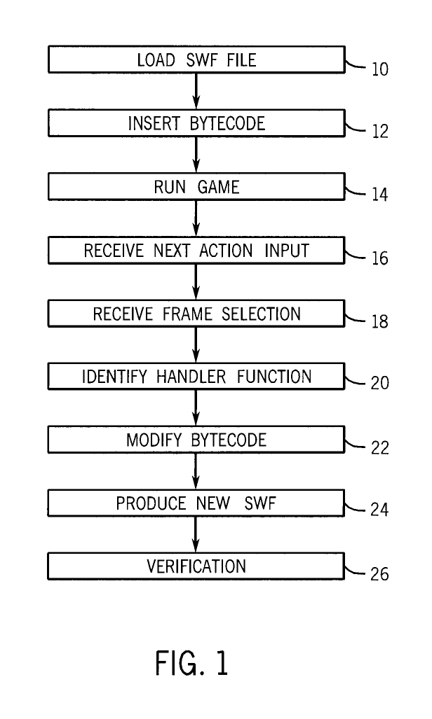

FIG. 1 is a flow diagram illustrating operations performed by an advertising delivery system in accordance with a representative embodiment. Additional, fewer, or different operations may be performed in alternative embodiments. In a representative embodiment, the delivery system allows for the insertion of a service that causes a presentation of advertisements within a FLASH program. In an alternative embodiment, the inserted service may cause a presentation of other content such as a survey or information regarding rival players or may cause an extraction of player achievement data. In an operation 10, a service insertion tool loads a SWF program file such as a SWF file for a game. In an operation 12, the service insertion tool modifies each function within the SWF game file by inserting a small portion of bytecode at the beginning of each function body. A function includes logic designated to cause the execution of various tasks by the Flash program. The functions can be defined by specific Flash bytecode instructions such as DefineFunction, DefineFunction2 for ActionScript 2.0, or AbcMethod table for ActionScript 3.0. The inserted bytecode creates a run-time output of a string that uniquely identifies the respective function within the SWF game file. In an operation 14, the game is played and the service insertion tool collects the run-time string outputs as the game is played. The service insertion tool uses the run-time string outputs to map the use of the functions throughout execution of the SWF game file. In this way, the service insertion tool can identify what functions are being utilized at varying points in the game.

In an operation 16, the service insertion tool receives an input from a technician indicating that the next action or input from the technician is to be a trigger for an advertisement or other type of content. In an operation 18, the service insertion tool receives a second input from the technician designating a frame or spot within the game where an advertisement or other content is to be triggered. Such a frame or spot may include the end of a level, the end of the game, or another spot within the game where the game is inactive and awaiting a user input. In an illustrative embodiment, the input may be a selection of a next level button or start new game button by the technician. In an operation 20, the service insertion tool identifies the first function executed in the SWF game file as a result of the input received from the technician designating the advertisement trigger. The service insertion tool identifies the first function based on the run-time string outputs and the mapped function use of the SWF file. The first function is a handler for the Flash object that represents the input received from the technician indicating the advertisement trigger. For example, the first function may be the handler for the Flash object representing a “next level” or “play again” button selected by the technician as the advertisement trigger. This handler function contains Flash bytecode that causes execution of the game to resume at an appropriate point, such as when a user selects the “next level” or “play again” button.

In an operation 22, the bytecode of the first function is modified to include additional logic that when executed causes a selected advertisement or other content to be presented in response to an occurrence of the designated advertisement trigger. At the conclusion of the advertisement, the handler function executes its original bytecode logic so that the game is resumed again at the appropriate point after termination of the advertisement. In an operation 24, the original SWF game file is transformed into a new enhanced SWF game file. As such, the modified bytecode of the functions used to cause the presentation of the advertisements is inserted into a new enhanced SWF game file along with the remaining unchanged portions of the original SWF game file. In an operation 26, the service insertion tool plays the game again allowing the technician to verify that the advertisement or other content is triggered and displayed as expected and that the game otherwise functions properly.

The service insertion tool allows a technician without specialized skill or knowledge in Flash programming or other types of programming to easily and efficiently insert a service that causes content such as advertisements to be presented in a Flash game. The service insertion tool also allows the enhanced SWF game file to be easily and quickly re-configured if and when the service insertion tool and original SWF game file are updated.

According to a representative embodiment, when the transformation is applied, only those elements of the game SWF that have modified functions are transformed in any way. The remaining elements of the SWF file are not modified. When the enhanced game SWF file is produced, those non-transformed elements of the SWF file are written to the enhanced game SWF file with exactly the same byte sequence as in the original game SWF file. Thus, any elements of the SWF file that are not involved in the transformation are guaranteed immutable and not subject to faulty interpretation and modification in the enhanced game SWF.

Later, when the game is played by a game player content may be presented in response to an occurrence of the selected content triggers based on an established service policy. A service policy may be downloaded at the start of the game from a service policy server or may be alternatively communicated to the enhanced game SWF file. The service policy contains instructions as to what content will be presented, when the content will be presented, and how the content will be presented.

The following further describes the service insertion tool and process used to transform a SWF-based game into a new enhanced SWF file that contains additional logic to display content such as video advertisements at appropriate points during game play as well as triggering events containing player achievement information that can be used by the hosting container (e.g. a website) to enable community based features.

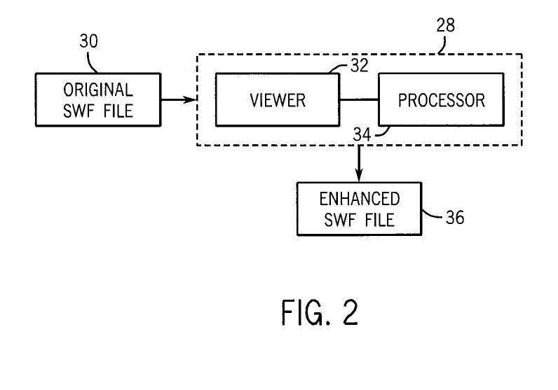

FIG. 2 illustrates components in a representative service insertion tool 28. Service insertion tool 28 includes a GUI-based viewer 32 and a processor 34. An original SWF file 30 is inputted into service insertion tool 28. Original SWF file 30 includes all logic necessary to execute the corresponding Flash program or game. Original SWF file 30 is loaded into service insertion tool 28. Viewer 32 displays the running Flash program or game and presents a user interface that allows a technician to interact with the game. Viewer 32 is further configured to receive inputs from the technician. Processor 34 is programmed to analyze the bytecode instructions contained in original SWF file 30, process inputs received from the technician, and implement modifications to the original SWF file 30 to cause content such as advertisements to be presented. Processor 34 may implement modifications by inserting pre-defined blocks of logic that handle initialization of data structures and execution of a service that causes content such as preroll and interstitial advertisements to be presented. Service insertion tool 28 produces an enhanced SWF file 36. Enhanced SWF file 36 includes the logic modified to insert a service that causes content and advertisements to be presented and any original logic that was unmodified during the service insertion process.

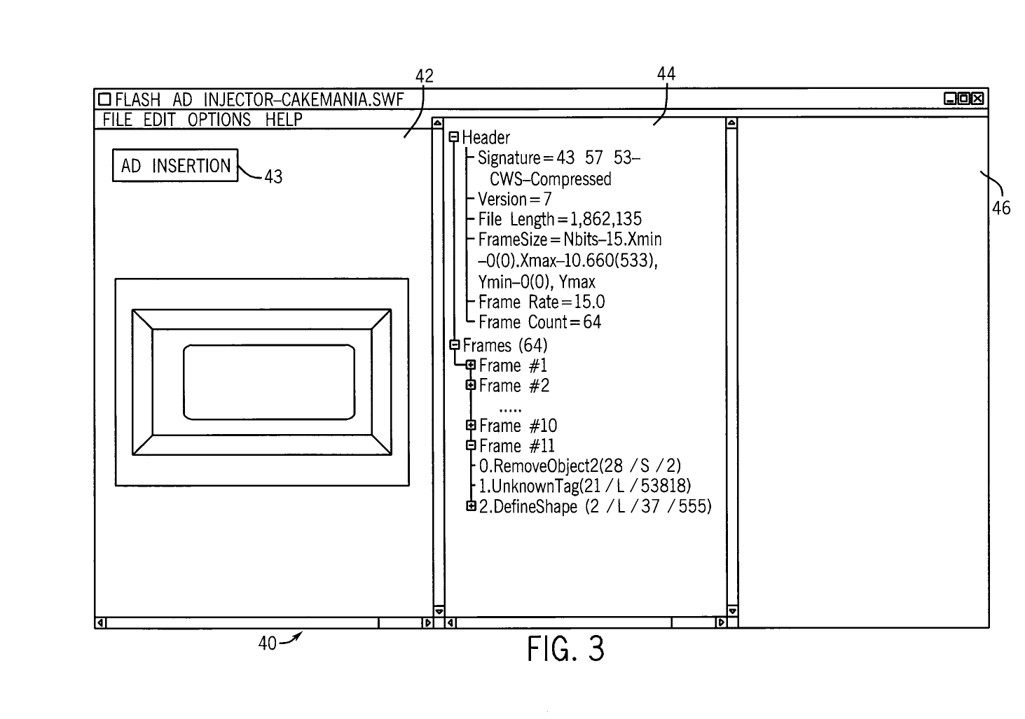

FIG. 3 illustrates a representative GUI (graphical user interface) 40. GUI 40 includes sections 42, 44, 46, and 48. Section 42 includes a panel showing the game running in an instance of the Flash player. The Flash game in section 42 is interactive and can be played. Within section 42 is an ad insertion button 43. Selection of ad insertion button 43 indicates that the next action or input from the technician is to designate a trigger for an advertisement or other type of content. Section 44 provides a visual representation of the properties in the header of the Flash program at the top and below a hierarchical representation of all the bytecode contained in the file. The bytecode is divided into a series of frames, each containing a hierarchical set of tags. While the game is being played, the frame number that is active may be highlighted in section 44. Section 46 may include the function currently be executed as the game is played as well as a list of past functions that were previously executed.

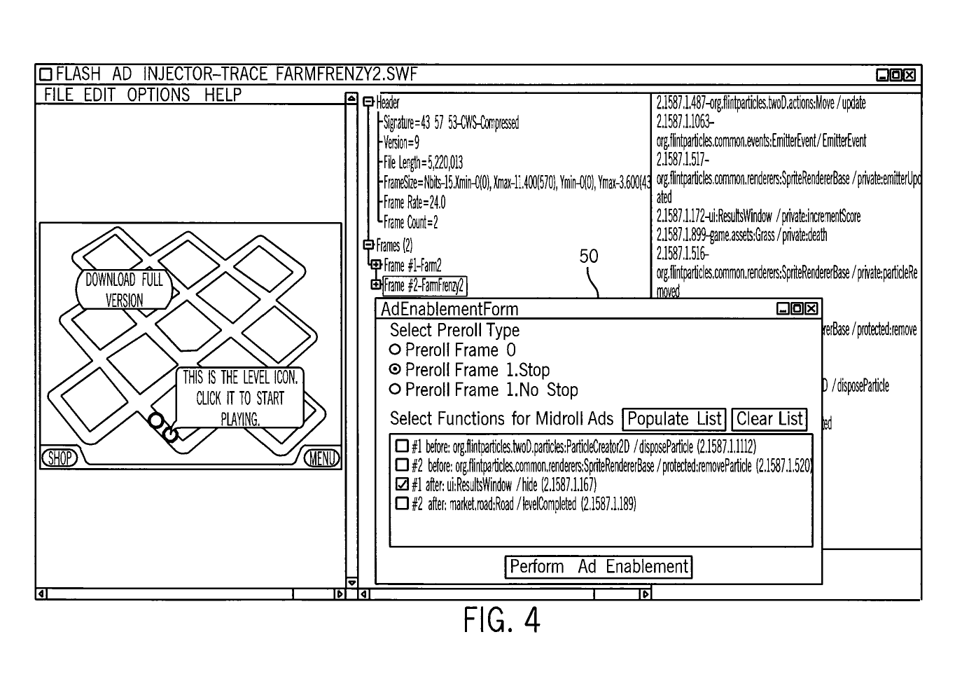

Modifications to the SWF file can cause presentation of a pre-roll advertisement (e.g., a video ad displayed during the initialization sequence for the game), presentation of an interstitial advertisement (e.g., a recurring video advertisement displayed during a natural breaking point in the game, such as between levels), and, at various points during game play, extraction of the user's score and generation of an event that is passed out from the Flash game to a website. To play an advertisement, the technician identifies a point where the Flash game playback can be paused while a video advertisement is shown. After a selection of ad insertion button 43, the next action or input from the technician received by the tool signifies a trigger for an advertisement. The service insertion tool determines the first function executed after this action or input from the technician and modifies this function to play an advertisement prior to resuming the game. FIG. 4 shows a representative graphical user interface after selection of a trigger. In an embodiment, after the action or input from the technician identifying the trigger, the service insertion tool may present a window 50 providing several possible functions to serve as triggers for the advertisement. As such, the service insertion tool may receive a selection of the precise function to serve as the trigger from the technician.

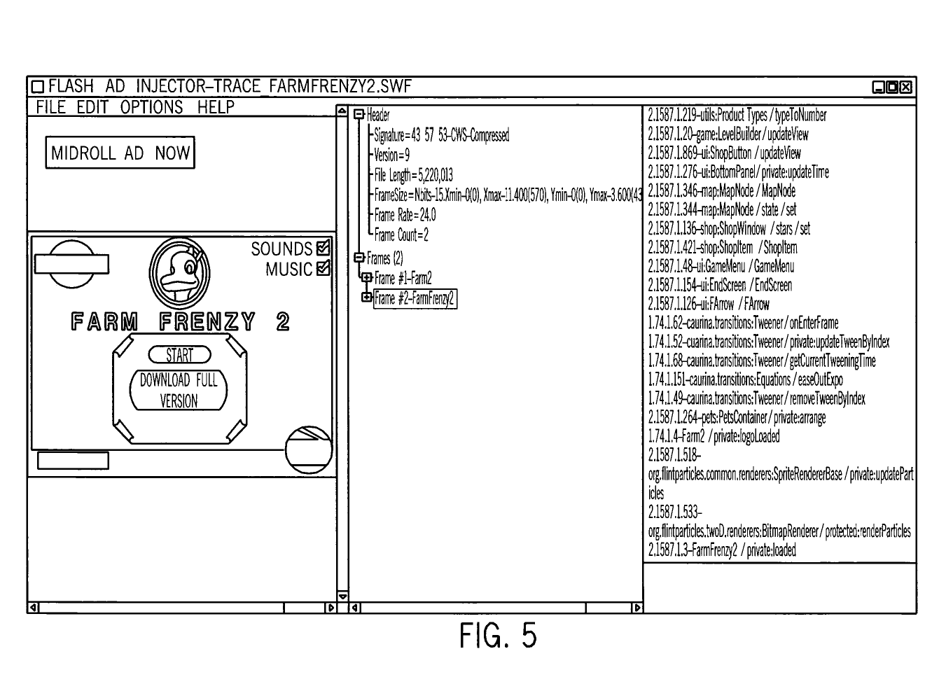

FIG. 5 shows a representative graphical user interface prior to selection of a function that starts a new game. An appropriate place to show a preroll advertisement is immediately before invoking this function. Therefore, the technician can select this as the point to insert the preroll advertisement and a pre-defined block of logic that plays an advertisement is inserted prior to this function by the service insertion tool. The function is modified such that logic to play an advertisement is inserted ahead this function call. When the advertisement is done, the advertisement playing logic invokes the function that starts the next level.

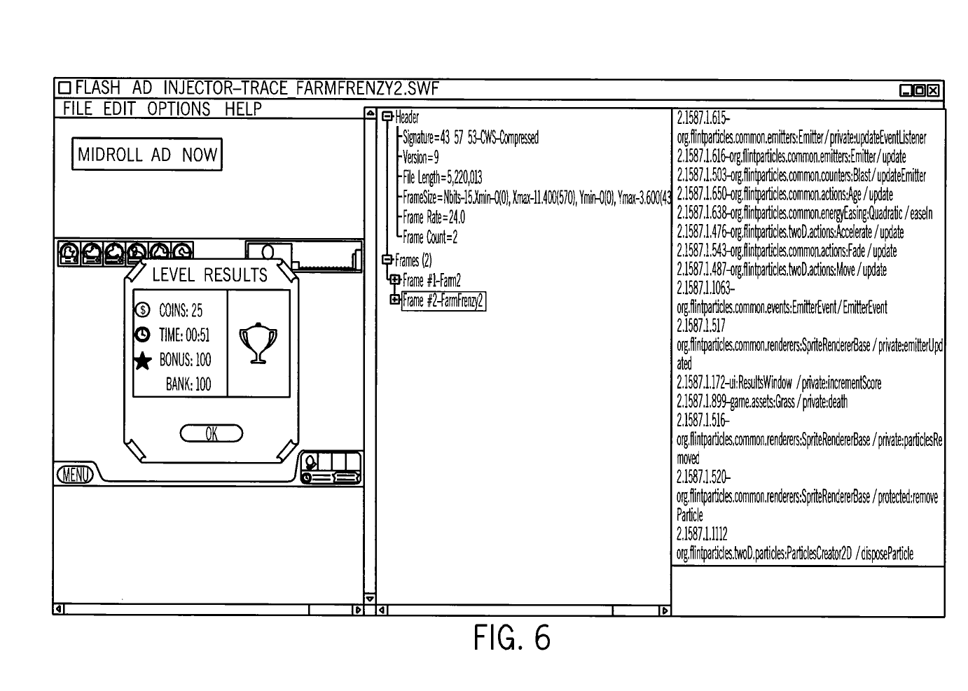

Similarly, the technician may identify a point in game play that occurs at a natural breaking point, such as between levels of a game. FIG. 6 shows a representative graphical user interface after completion of a level of the game. The technician may submit an input designating a trigger for the advertisement (i.e., selection of a next level button). The service insertion tool identifies a block of logic within the game SWF file that is executed at each of these break points, and selects a function ahead of which the logic for displaying an advertisement is inserted.

For extracting and exposing player achievement information, the service insertion tool identifies the variable(s) within the SWF game logic that store the player's score, current level, and other items of interest. Once these variables are identified, the service insertion tool inserts logic into the game SWF to trigger an event that passes the value of this variable out to the container that is hosting the game SWF. In most cases, this event is exposed to the JavaScript in the web page that is hosting the Flash player object.

At the end of the process described above, the technician and service insertion tool have produced an enhanced game SWF file. The output of the service insertion tool is the enhanced game SWF file in which the user experience of the game remains identical to the original with the exception of the addition of a service that may cause video advertisements to be presented at specific points during game play. This enhanced game SWF file is saved and can be packaged and distributed in the same manner as the original game. Because the advertisement display logic is built right into the SWF game file itself, even if unauthorized websites obtain and host this modified game, they will also display advertisements and the advertisement revenue will flow to the company that originally hosted the enhanced game SWF. This scenario is in contrast to the traditional model of generating advertising revenue for hosted Flash games in which the SWF game file itself contains no advertisement display logic. In this case, advertisements are displayed by the HTML page that surrounds the Flash player object that is executing the game. In this case, any unauthorized capture and hosting of the game SWF file will enable an unauthorized website to host the game without any advertising revenue going to the company that originally hosted the game SWF.

In another representative embodiment, a pre-roll advertisement is added automatically without involvement of a technician. Automatic addition of a pre-roll advertisement includes the addition of preroll advertisement delivery bytecode logic at the beginning of a computer program, such as a game, prior to any of the game bytecode being executed. In some cases, adding a bytecode requires the creation of a new frame on the main Flash timeline. In other cases, such an addition requires reordering of existing frames on the timeline and/or scanning all the bytecode within the file to adjust any references within the bytecode to absolute frame numbers, which are changed as a result of the addition of a new frame for the preroll advertisement at the beginning of the SWF.

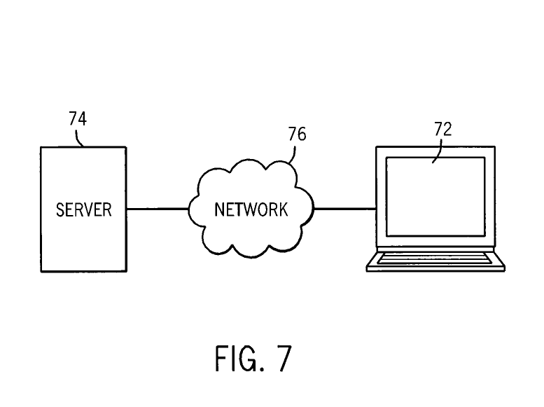

In yet another representative embodiment, a beaconing service is included with the Flash game that does not require a technician to examine the game and define the transformation operation. FIG. 7 illustrates a beaconing operation in which a message is sent from a computer 72 on which the game is played to a server 74 via a network 76. The message provides information regarding the game session durations while the game is being played. As such, the server 74 can receive information on the length of each game play session. Without such messaging, an operator of a Flash gaming website cannot determine how long each game play session lasts because after the game SWF is loaded onto the webpage and starts executing, it typically no longer makes any contact with the server. Without the beacon messages, the website operator does not know at what point the user closes the browser window or navigates away from the page hosting the game SWF to another page. With the beaconing messages added to the game, the website operator knows, subject to the frequency of the messages, how long the user's game session lasts.

It is important to understand that any of the embodiments described herein may be implemented as computer-readable instructions stored on a computer-readable medium. Upon execution by a processor, the computer-readable instructions can cause a computing device to perform operations to implement any of the embodiments described herein. For example, in an embodiment, the service insertion tool may be stored on a memory of a computer as a computer-readable medium. The memory may be operatively connected to a CPU which may process the computer-readable medium thereby running the service insertion tool. In addition, the CPU and the memory may be connected to a display which is configured to present visual representations of the service insertion tool.

The foregoing description has been presented for purposes of illustration and of description. It is not intended to be exhaustive or limiting with respect to the precise form disclosed, and modifications and variations are possible in light of the above teachings or may be acquired from practice of the disclosed embodiments.

What is claimed is:

1. A method of associating a service with a computer software product, the method comprising:
loading an executable software file containing software code that upon execution carries out a software program;
receiving, via a user interface of a service insertion tool, an input identifying a content trigger within the software program;
identifying, via the service insertion tool, a function of the software file associated with the content trigger; and
modifying, via the service insertion tool, the function of the software file, wherein the function is configured to cause presentation of content in response to an occurrence of the content trigger.

2. The method of claim 1, wherein the software program includes a software game.

3. The method of claim 1, further comprising:
inserting code into a plurality of functions of the software file via the service insertion tool; and
mapping, via the service insertion tool, execution of the plurality of functions during execution of the software file.

4. The method of claim 2, further comprising presenting a player interface in the user interface, wherein the player interface presents the software game.

5. The method of claim 3, further comprising presenting a first visual representation of header properties of the software program and a second visual representation of executed functions of the software file.

6. The method of claim 4, wherein the bytecode is divided into a series of frames.

7. The method of claim 1, wherein the software program is a Flash program including a game.

8. The method of claim 1, further comprising receiving, via the user interface of the service insertion tool, a second input configured to indicate that a subsequent input will identify the service trigger.

9. The method of claim 1, wherein the user interface is configured to present output of the software program during execution and receive input associated with points in time during runtime of the software program.

10. The method of claim 1, further comprising producing an enhanced software file comprising the modified function.

11. A tool for associating a service with a computer software product, the tool comprising:
a viewer configured to present a software program in a user interface and receive user inputs via the user interface; and
a processor configured to
execute programmed instructions to receive an input, via the user interface, identifying a content trigger within the software program;
identify a function of a software file for the software program, wherein the function is associated with the content trigger; and
modify the function of the software file, wherein the function is configured to cause presentation of content in response to an occurrence of the content trigger.

12. The tool of claim 11, wherein the software program includes a software game.

13. The tool of claim 11, wherein the processor is further configured to:
insert code into a plurality of functions of the software file; and
map execution of the plurality of functions during execution of the software file.

14. The tool of claim 11, wherein the software file is a Shockwave Flash file.

15. The tool of claim 11, wherein the user interface includes a software program player that presents the software program.

16. The tool of claim 11, wherein the user interface includes an input section for receiving a second input indicating that a subsequent input will identify the content trigger.

17. The tool of claim 11, wherein the software program includes a game.

18. The tool of claim 11, wherein the processor is further configured to produce an enhanced software file comprising the modified function.

19. A computer-readable medium having computer-readable instructions stored thereon, which when executed by a processor, cause a computing device to:
load an executable software file containing software code that upon execution carries out a software program;
receive an input identifying a content trigger within the software program;
identify a function of the software file associated with the content trigger; and
modify the function of the software file, wherein the function is configured to cause presentation of content in response to an occurrence of the content trigger.

20. The computer-readable medium of claim 19, wherein the software program is a Flash program including a game.

21. The computer-readable medium of claim 20, wherein the computer-readable instructions further cause a computing device to:
input code into a plurality of functions of the software file; and
map execution of the plurality of functions during execution of the software file.
